(19) United States
(12) Patent Application Publication
(10) Pub. No.: US 2012/0168979 A1
(43) Pub. Date: Jul. 5, 2012

(54) METHOD OF FORMING A SHAPED ABRASIVE PARTICLE

(75) Inventors: Ralph Bauer, Niagara Falls (CA); Martin Barnes, Youngstown, NY (US); Yves Boussant-Roux, Lexington, MA (US); Jennifer H. Czerepinski, Frammingham, MA (US); Doruk O. Yener, Wilmington, MA (US)

(73) Assignee: SAINT-GOBAIN CERAMICS & PLASTICS, INC., Worcester, MA (US)

(21) Appl. No.: 13/341,664

(22) Filed: Dec. 30, 2011

Related U.S. Application Data
(60) Provisional application No. 61/428,575, filed on Dec. 30, 2010.

(51) Int. Cl. B29B 9/02

(52) U.S. Cl. 264/141

(57) ABSTRACT

A method for making abrasive grains, the method comprising mixing one or more solids with one or more liquids in a twin screw extruder to form a mixture, transferring the mixture to a high pressure piston extruder; and extruding the mixture from the high pressure piston extruder through a die to form an extrude. The method further includes segmenting the extrudate to form extruded shaped abrasive particles.

### CROSS-REFERENCE TO RELATED APPLICATION(S)

The present application claims priority from U.S. Provisional Patent Application No. 61/428,575, filed Dec. 30, 2010, entitled “METHOD OF FORMING A SHAPED ABRASIVE PARTICLE,” naming inventors Ralph Bauer et al., which application is incorporated by reference herein in its entirety.

### FIELD OF THE DISCLOSURE

This disclosure, in general, relates to methods and systems for forming structured abrasive articles. More particularly, this disclosure relates to forming of shaped abrasive particles through an extrusion process.

### BACKGROUND

### DESCRIPTION OF THE RELATED ART

Abrasive articles, such as coated abrasives and bonded abrasives, are used in various industries to machine workpieces, such as by lapping, grinding, or polishing. Machining utilizing abrasive articles spans a wide industrial scope from optics industries, automotive paint repair industries, to metal fabrication industries. In each of these examples, manufacturing facilities use abrasives to remove bulk material or affect surface characteristics of products.

Surface characteristics include shine, texture, and uniformity. For example, manufacturers of metal components use abrasive articles to fine and polish surfaces, and oftentimes desire a uniformly smooth surface. Similarly, optics manufacturers desire abrasive articles that produce defect free surfaces to prevent light diffraction and scattering.

Manufactures also desire abrasive articles that have a high stock removal rate for certain applications. However, there is often a trade-off between removal rate and surface quality. Finer grain abrasive articles typically produce smoother surfaces, yet have lower stock removal rates. Lower stock removal rates lead to slower production and increased cost.

Particularly in the context of coated abrasive articles, manufactures of abrasive articles have introduced surface structures to improve stock removal rate, while maintaining surface quality. Coated abrasive articles having surface structures or patterns of raised abrasive layers, often called engineered or structured abrasives, typically exhibit improved useful life.

However, typical techniques for forming structured abrasive articles are unreliable and suffer from performance limitations. A typical process for forming a structured abrasive article includes coating a backing with a viscous binder, coating the viscous binder with a functional powder, and stamping or rolling structure patterns into the viscous binder. The functional powder prevents the binder from sticking to patterning tools. The binder is subsequently cured.

Imperfect coating of the viscous binder with functional powder leads to binder sticking on patterning tools. Binder sticking produces poor structures, leading to poor product performance and wasted product.

Selection of binders appropriate for typical structured abrasive formation techniques is limited by the process. Typical binders include high loading of traditional fillers that increase the viscosity of the binder. Such traditional fillers affect the mechanical characteristics of the binder. For example, high loading of traditional fillers may adversely affect tensile strength, tensile modulus, and elongation at break characteristics of the binder. Poor mechanical characteristics of the binder allow for loss of abrasive grains, leading to scratching and haze on surfaces and reducing abrasive article life.

Loss of grains also degrades the performance of abrasive articles, leading to frequent replacement. Frequent abrasive article replacement is costly to manufacturers. As such, improved abrasive articles and methods for manufacturing abrasive articles would be desirable.

### SUMMARY

A method for making abrasive particles is disclosed and may include mixing one or more solids with one or more liquids in a twin screw extruder to form a mixture. The method may also include transferring the mixture to a high pressure piston extruder and extruding the mixture from the high pressure piston extruder through a die to form an extrudate. Further, the method may include segmenting the extrudate to form extruded shaped abrasive particles.

In another aspect, a method for making abrasive particles is disclosed and may include mixing one or more solids with one or more liquids in a twin screw extruder to form a mixture and extruding the mixture to form a puck. Moreover, the method may include transferring the puck to a high pressure piston extruder and extruding the puck through a die to form an extrudate.

In yet another aspect, a method for making abrasive grains is disclosed and may include mixing one or more solids with one or more liquids in a twin screw extruder to form a mixture, shearing the mixture, applying a vacuum to the mixture to remove water from the mixture, and extruding a puck from the twin screw extruder. The puck may include a water content of at least about 30 wt % for the total weight of the puck. The method may also include transferring the mixture to a high pressure piston extruder, extruding the mixture from the high pressure piston extruder through a die to form an extrudate, and segmenting the extrudate to form extruded shaped abrasive particles.

In still another aspect, a method for making abrasive grains is disclosed and may include mixing one or more solids with one or more liquids in a twin screw extruder to form a mixture and transferring the mixture to a high pressure piston extruder. Further, the method may include segmenting the mixture from the high pressure piston extruder through a die to form an extrudate and segmenting the extrudate to form extruded shaped abrasive particles. Each extruded shaped abrasive particle may have an aspect ratio defined by a ratio of a ratio of length:height of at least 2:1.

### BRIEF DESCRIPTION OF THE DRAWINGS

The present disclosure may be better understood, and its numerous features and advantages made apparent to those skilled in the art by referencing the accompanying drawings.

FIG. 1 is a diagram of a system for making extruded abrasive grains;

FIG. 2 is a detailed view of an extruded material;

FIG. 3 is a plan view of a first embodiment of a die;

FIG. 4 is a plan view of a second embodiment of a die;

FIG. 5 is a plan view of a third embodiment of a die;

FIG. 6 is a plan view of a fourth embodiment of a die;

FIG. 7 is a plan view of a fifth embodiment of a die;

FIG. 8 is a plan view of a sixth embodiment of a die;

FIG. 9 is a plan view of a seventh embodiment of a die;

FIG. 10 is a plan view of an eighth embodiment of a die;

FIG. 11 is a plan view of a ninth embodiment of a die;

FIG. 12 is a plan view of a tenth embodiment of a die;

FIG. 13 is a plan view of an eleventh embodiment of a die;

FIG. 14 is a plan view of a twelfth embodiment of a die;

FIG. 15 is a plan view of a thirteenth embodiment of a die;

FIG. 16 is a plan view of a fourteenth embodiment of a die;

FIG. 17 is a plan view of a fifteenth embodiment of a die;

FIG. 18 is a plan view of a sixteenth embodiment of a die;

FIG. 19 is a plan view of a seventeenth embodiment of a die;

FIG. 20 is a plan view of a eighteenth embodiment of a die;

FIG. 21 is a plan view of a nineteenth embodiment of a die;

FIG. 22 is a flow chart illustrating a first portion of a method of making extruded shaped abrasive particles;

FIG. 23 is a flow chart illustrating a second portion of the method of making extruded shaped abrasive particles;

FIG. 24 is a diagram of an exemplary process; and

FIG. 25 is a perspective view of a structured abrasive article.

FIG. 26 is a plot of normal force versus grinding time for a sample of extruded shaped abrasive particles according to an embodiment.

FIG. 27 is a plot of cumulative material removed versus time for a conventional, crushed abrasive grit and an extruded shaped abrasive particle according to an embodiment.

The use of the same reference symbols in different drawings indicates similar or identical items.

### DETAILED DESCRIPTION

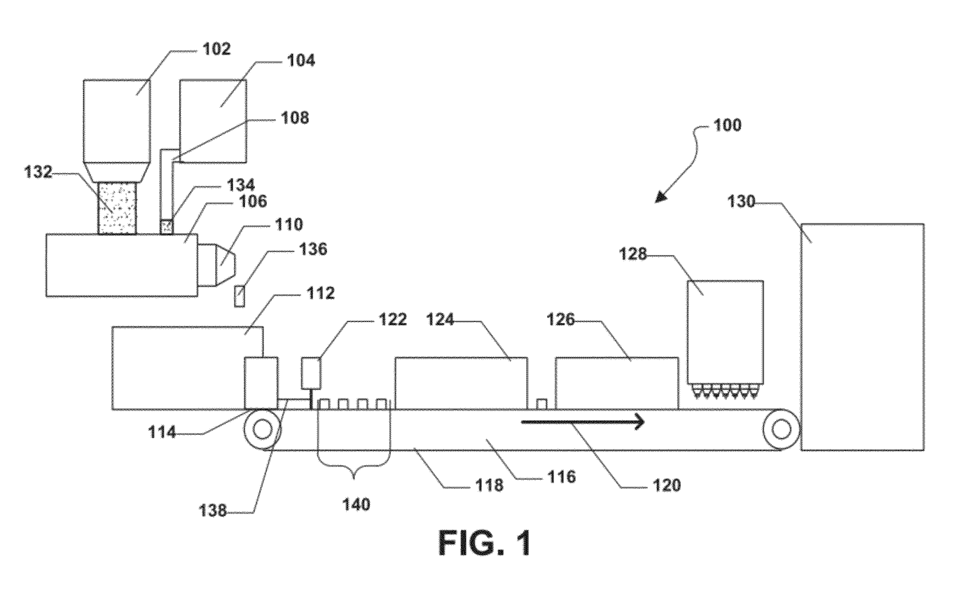

Referring initially to FIG. 1, a system for making extruded shaped abrasive particles is shown and is generally designated 100. As shown, the system 100 may include a solid materials hopper 102 and a liquid reservoir 104. A twin screw extruder 106 may be placed beneath the raw material hopper 102. Further, a pipe 108 may extend from the liquid reservoir 104 such that the pipe 108 is in close proximity to the twin screw extruder 104. As illustrated, the twin screw extruder 104 may include a die 110.

The system 100 may also include a high pressure piston extruder 112 below, or otherwise adjacent to, the twin screw extruder 104. Specifically, the piston extruder 112 may be situated so that material extruded from the die opening 110 of the twin screw extruder 104 may be transferred to the piston extruder 112, either directly or indirectly via a conveyance mechanism, e.g., a conveyer belt system. FIG. 1 further depicts that the piston extruder 112 may include a die 114. It can be appreciated that the die 114 may include one or more die openings (not show).

FIG. 1 further illustrates a conveyor belt assembly 116 adjacent to the piston extruder 112. Specifically, the conveyor belt assembly 116 may be situated so that material extruded from the piston extruder 112 via the die 114 may be deposited on a conveyor belt 118 of the conveyor belt assembly 116 and carried away from the piston extruder 112 in a downstream direction as indicated by arrow 120.

As shown in FIG. 1, a tool 122 may be placed downstream from the piston extruder 112 above the conveyor belt assembly 116 to facilitate segmenting the extrudate to form extruded shaped abrasive particles. The tool 122 may be, for example, a wire.

FIG. 1 shows that a controlled humidity oven 124 may be placed along the conveyor belt assembly 116 downstream from the tool 122 such that the conveyor belt 118 and anything deposited on the conveyor belt 118 from the piston extruder 112 passes through the controlled humidity oven 124.

A box oven 126 may be placed along the conveyor belt assembly 116 downstream from the controlled humidity oven 124 and the conveyor belt 118 and anything deposited on the conveyor belt 118 may pass through the box oven 126. Moreover, a sprayer 128 may be situated above the conveyor belt 118 downstream from the box oven 126 and the conveyor belt 118 and any material on the conveyor belt 118 may pass under the sprayer 128. Further, a rotary kiln 130 may be placed at or near the end of the conveyor belt assembly 116 so that materials from the conveyor belt 118 may be deposited in the rotary kiln 130 for drying.

During operation, solid materials 132 may be deposited into the twin screw extruder 106 from the solid materials hopper 102. Further, a liquid 134 may be introduced into the twin screw extruder 106 from the liquid reservoir 104 via the pipe 108. The twin screw extruder 106 may be used to thoroughly mix the solid materials 132 and the liquid 134. Further, the twin screw extruder 106 may shear the mixture and apply a vacuum to the mixture to ensure mixing and to ensure the removal of air from the mixture.

Once the solid materials 132 and the liquid 134 are thoroughly mixed in the twin screw extruder 106, the twin screw extruder 106 may extrude the mixture 136 into the high pressure piston extruder 112, either directly or indirectly. The high pressure piston extruder 112 can extruder the mixture 136 through the die 114 to form an extrudate 138. It can be appreciated that the high pressure piston extruder 112 may provide a uniform extrusion rate across the die face. Further, the use of the high pressure piston extruder 112 may facilitate use of a mixture 136 having a high solids content and facilitate forming shaped abrasive particles according to the embodiments herein.

In a particular aspect, the water content can be at least about 30 wt % for the total weight of the extrudate. In another aspect, the water content can be at least about 35 wt %, such as at least about 40 wt %, such as at least about 45 wt %, at least about 50 wt %, at least about 55 wt %, at least about 60 wt %, at least about 65 wt %, at least about 70 wt % or even at least about 75 wt %. Still, in one non-limiting embodiment, the water content of the extrudate can be not greater than about 85 wt %, such as not greater than about 84 wt %, not greater than about 83 wt %, not greater than about 82 wt %, not greater than about 81 wt %, not greater than about 80 wt %, not greater than about 79 wt %, such as not greater than about 78 wt %, not greater than about 77 wt %, not greater than about 76 wt %, or even not greater than about 75 wt %.

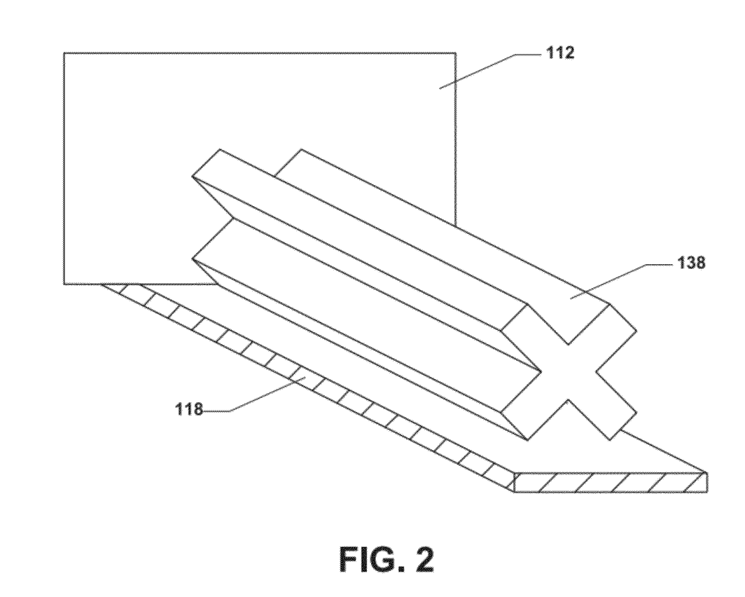

Referring briefly to FIG. 2, the extrudate 138 is shown as it is exiting the high pressure piston extruder 112 onto the conveyor belt 118. In this particular aspect, the extrudate 138 may have a cross section perpendicular to a longitudinal axis that is generally X shaped. However, the extrudate 138 may have any cross-sectional shape, which can be a two-dimensional shape, including for example, any polygonal cross-sectional shape. Examples of such shapes are described herein in conjunction with various dies.

Referring back to FIG. 1, the extrusion 138 may pass underneath the tool 122 which may segment the extrudate 138 into individual extruded shaped abrasive particles 140. The tool 122 may utilize, for example, a wire to segment the extrudate uniformly and with minimal distortion. Further, it can be appreciated that a parting agent may be introduced into the mixture in order to minimize the stickiness of the extruded shaped abrasive particles 140 so the extruded shaped abrasive particles 140 do not stick to one another upon contact even in the wet state.

After the extruded shaped abrasive particles 140 are segmented, the conveyor belt 118 can convey the extruded shaped abrasive particles 140 into the controlled humidity oven 124. The extruded shaped abrasive particles 140 may stay in the controlled humidity oven 124 for a predetermined drying time at a predetermined drying temperature and a predetermined relative humidity.

In this aspect, the drying time may be at least about two minutes. In another aspect, the drying time may be at least about three minutes. In another aspect, the drying time may be at least about four minutes. In yet another aspect, the drying time may be at least about five minutes. In still another aspect, the drying time may be at least about six minutes. In another aspect, the drying time may be at least about seven minutes. In another aspect, the drying time may be at least about eight minutes. In another aspect, the drying time may be at least about nine minutes. In yet another aspect, the drying time may be at least about ten minutes.

In another aspect, the drying time may be at least about one hour. In another aspect, the drying time may be at least about one and one-half hours. In another aspect, the drying time may be at least about two hours. In another aspect, the drying time may be at least about two and one-half hours. In another aspect, the drying time may be at least about three hour. In another aspect, the drying time may be at least about three and one-half hours. In another aspect, the drying time may be at least about four hours. In another aspect, the drying time may be at least about four and one-half hours. In another aspect, the drying time may be at least about five hours.

In another aspect, the drying time may be at least about twelve hours. In another aspect, the drying time may be at least about twelve and one-half hours. In another aspect, the drying time may be at least about thirteen hours. In another aspect, the drying time may be at least about thirteen and one-half hours. In another aspect, the drying time may be at least about fourteen hours. In another aspect, the drying time may be at least about fourteen and one-half hours. In another aspect, the drying time may be at least about fifteen hours. In another aspect, the drying time may be at least about fifteen and one-half hours. In another aspect, the drying time may be at least about sixteen hours.

In another aspect, the drying time may be no greater than about twenty hours. In another aspect, the drying time may be no greater than about nineteen and one-half hours. In another aspect, the drying time may be no greater than about nineteen hours. In another aspect, the drying time may be no greater than about eighteen and one-half hours. In another aspect, the drying time may be no greater than about eighteen hours. In another aspect, the drying time may be no greater than about seventeen and one-half hours. In another aspect, the drying time may be no greater than about seventeen hours. In another aspect, the drying time may be no greater than about sixteen and one-half hours. In another aspect, the drying time may be no greater than about sixteen hours.

In this aspect, the drying temperature may be at least about thirty degrees Celsius (30° C.). In another aspect, the drying temperature may be at least about thirty-five degrees Celsius (35° C.). In another aspect, the drying temperature may be at least about forty degrees Celsius (40° C.). In another aspect, the drying temperature may be at least about forty-five degrees Celsius (45° C.). In still another aspect, the drying temperature may be at least about fifty degrees Celsius (50° C.). In another aspect, the drying temperature may be at least about fifty-five degrees Celsius (55° C.). In yet another aspect, the drying temperature may be at least about sixty degrees Celsius (60° C.). In another aspect, the drying temperature may be at least about sixty-five degrees Celsius (65° C.). In still yet another aspect, the drying temperature may be at least about seventy degrees Celsius (70° C.). In another aspect, the drying temperature may be at least about seventy-five degrees Celsius (75° C.). In another aspect, the drying temperature may be at least about eighty degrees Celsius (80° C.).

In another aspect, the drying temperature may be no greater than about ninety degrees Celsius (90° C.). In another aspect, the drying temperature may be no greater than about eighty-nine degrees Celsius (89° C.). In another aspect, the drying temperature may be no greater than about eighty-seven degrees Celsius (87° C.). In another aspect, the drying temperature may be no greater than about eighty-five degrees Celsius (85° C.). In another aspect, the drying temperature may be no greater than about eighty-three degrees Celsius (83° C.). In another aspect, the drying temperature may be no greater than about eighty-two degrees Celsius (82° C.). In another aspect, the drying temperature may be no greater than about eighty-one degrees Celsius (81° C.). In another aspect, the drying temperature may be no greater than about eighty degrees Celsius (80° C.).

In a particular aspect, the relative humidity may be at least about forty percent (40%). In another aspect, the relative humidity may be at least about forty-five percent (45%). In yet another aspect, the relative humidity may be at least about fifty percent (50%). In another aspect, the relative humidity may be at least about fifty-five percent (55%). In still another aspect, the relative humidity may be at least about sixty percent (60%). In another aspect, the relative humidity may be at least about sixty-five percent (65%). In yet another aspect, the relative humidity may be at least about seventy percent (70%). In another aspect, the relative humidity may be at least about seventy-five percent (75%). In yet another aspect, the relative humidity may be at least about eighty percent (80%). In another aspect, the relative humidity may be at least about eighty-five percent (85%).

In yet another aspect, the relative humidity may be no greater than ninety percent (90%). In another aspect, the relative humidity may be no greater than eighty-nine percent (89%). In another aspect, the relative humidity may be no greater than eighty-eight percent (88%). In another aspect, the relative humidity may be no greater than eighty-seven percent (87%). In another aspect, the relative humidity may be no greater than eighty-six percent (86%). In another aspect, the relative humidity may be no greater than eighty-five percent (85%).

After a stay in the controlled humidity oven 124, the conveyor belt 118 may convey the extruded shaped abrasive particles 140 to the box oven 126 wherein the extruded shaped abrasive particles 140 may stay for a predetermined drying time at a predetermined drying temperature.

In this aspect, the drying time may be at least about two minutes. In another aspect, the drying time may be at least about three minutes. In another aspect, the drying time may be at least about four minutes. In yet another aspect, the drying time may be at least about five minutes. In still another aspect, the drying time may be at least about six minutes. In another aspect, the drying time may be at least about seven minutes. In another aspect, the drying time may be at least about eight minutes. In another aspect, the drying time may be at least about nine minutes. In yet another aspect, the drying time may be at least about ten minutes.

In another aspect, the drying time may be at least about one hour. In another aspect, the drying time may be at least about one and one-half hours. In another aspect, the drying time may be at least about two hours. In another aspect, the drying time may be at least about two and one-half hours. In another aspect, the drying time may be at least about three hour. In another aspect, the drying time may be at least about three and one-half hours. In another aspect, the drying time may be at least about four hours. In another aspect, the drying time may be at least about four and one-half hours. In another aspect, the drying time may be at least about five hours.

In another aspect, the drying time may be at least about twelve hours. In another aspect, the drying time may be at least about twelve and one-half hours. In another aspect, the drying time may be at least about thirteen hours. In another aspect, the drying time may be at least about thirteen and one-half hours. In another aspect, the drying time may be at least about fourteen hours. In another aspect, the drying time may be at least about fourteen and one-half hours. In another aspect, the drying time may be at least about fifteen hours. In another aspect, the drying time may be at least about fifteen and one-half hours. In another aspect, the drying time may be at least about sixteen hours.

In another aspect, the drying time may be no greater than about twenty hours. In another aspect, the drying time may be no greater than about nineteen and one-half hours. In another aspect, the drying time may be no greater than about nineteen hours. In another aspect, the drying time may be no greater than about eighteen and one-half hours. In another aspect, the drying time may be no greater than about eighteen hours. In another aspect, the drying time may be no greater than about seventeen and one-half hours. In another aspect, the drying time may be no greater than about seventeen hours. In another aspect, the drying time may be no greater than about sixteen and one-half hours. In another aspect, the drying time may be no greater than about sixteen hours.

In this aspect, the drying temperature may be at least about thirty degrees Celsius (30° C.). In another aspect, the drying temperature may be at least about thirty-five degrees Celsius (35° C.). In another aspect, the drying temperature may be at least about forty degrees Celsius (40° C.). In another aspect, the drying temperature may be at least about forty-five degrees Celsius (45° C.). In still another aspect, the drying temperature may be at least about fifty degrees Celsius (50° C.). In another aspect, the drying temperature may be at least about fifty-five degrees Celsius (55° C.). In yet another aspect, the drying temperature may be at least about sixty degrees Celsius (60° C.). In another aspect, the drying temperature may be at least about sixty-five degrees Celsius (65° C.). In still yet another aspect, the drying temperature may be at least about seventy degrees Celsius (70° C.). In another aspect, the drying temperature may be at least about seventy-five degrees Celsius (75° C.). In another aspect, the drying temperature may be at least about eighty degrees Celsius (80° C.).

In another aspect, the drying temperature may be no greater than about ninety degrees Celsius (90° C.). In another aspect, the drying temperature may be no greater than about eighty-nine degrees Celsius (89° C.). In another aspect, the drying temperature may be no greater than about eighty-seven degrees Celsius (87° C.). In another aspect, the drying temperature may be no greater than about eighty-five degrees Celsius (85° C.). In another aspect, the drying temperature may be no greater than about eighty-three degrees Celsius (83° C.). In another aspect, the drying temperature may be no greater than about eighty-two degrees Celsius (82° C.). In another aspect, the drying temperature may be no greater than about eighty-one degrees Celsius (81° C.). In another aspect, the drying temperature may be no greater than about eighty degrees Celsius (80° C.).

After the extruded shaped abrasive particles 140 leave the box oven 126, the conveyor belt 118 may convey the extruded shaped abrasive particles 140 beneath the sprayer 128 and a size coating may be applied to the extruded shaped abrasive particles 140. Finally, the extruded shaped abrasive particles 140 may be deposited into the rotary kiln 130 wherein the extruded shaped abrasive particles 140 may stay for a predetermined drying time at a predetermined drying temperature.

In this aspect, the drying time may be at least about two minutes. In another aspect, the drying time may be at least about three minutes. In another aspect, the drying time may be at least about four minutes. In yet another aspect, the drying time may be at least about five minutes. In still another aspect, the drying time may be at least about six minutes. In another aspect, the drying time may be at least about seven minutes. In another aspect, the drying time may be at least about eight minutes. In another aspect, the drying time may be at least about nine minutes. In yet another aspect, the drying time may be at least about ten minutes.

In another aspect, the drying time may be at least about one hour. In another aspect, the drying time may be at least about one and one-half hours. In another aspect, the drying time may be at least about two hours. In another aspect, the drying time may be at least about two and one-half hours. In another aspect, the drying time may be at least about three hour. In another aspect, the drying time may be at least about three and one-half hours. In another aspect, the drying time may be at least about four hours. In another aspect, the drying time may be at least about four and one-half hours. In another aspect, the drying time may be at least about five hours.

In another aspect, the drying time may be at least about twelve hours. In another aspect, the drying time may be at least about twelve and one-half hours. In another aspect, the drying time may be at least about thirteen hours. In another aspect, the drying time may be at least about thirteen and one-half hours. In another aspect, the drying time may be at least about fourteen hours. In another aspect, the drying time may be at least about fourteen and one-half hours. In another aspect, the drying time may be at least about fifteen hours. In another aspect, the drying time may be at least about fifteen and one-half hours. In another aspect, the drying time may be at least about sixteen hours.

In another aspect, the drying time may be no greater than about twenty hours. In another aspect, the drying time may be no greater than about nineteen and one-half hours. In another aspect, the drying time may be no greater than about nineteen hours. In another aspect, the drying time may be no greater than about eighteen and one-half hours. In another aspect, the drying time may be no greater than about eighteen hours. In another aspect, the drying time may be no greater than about seventeen and one-half hours. In another aspect, the drying time may be no greater than about seventeen hours. In another aspect, the drying time may be no greater than about sixteen and one-half hours. In another aspect, the drying time may be no greater than about sixteen hours.

In this aspect, the drying temperature may be at least about thirty degrees Celsius (30° C.). In another aspect, the drying temperature may be at least about thirty-five degrees Celsius (35° C.). In another aspect, the drying temperature may be at least about forty degrees Celsius (40° C.). In another aspect, the drying temperature may be at least about forty-five degrees Celsius (45° C.). In still another aspect, the drying temperature may be at least about fifty degrees Celsius (50° C.). In another aspect, the drying temperature may be at least about fifty-five degrees Celsius (55° C.). In yet another aspect, the drying temperature may be at least about sixty degrees Celsius (60° C.). In another aspect, the drying temperature may be at least about sixty-five degrees Celsius (65° C.). In still yet another aspect, the drying temperature may be at least about seventy degrees Celsius (70° C.). In another aspect, the drying temperature may be at least about seventy-five degrees Celsius (75° C.). In another aspect, the drying temperature may be at least about eighty degrees Celsius (80° C.).

In another aspect, the drying temperature may be no greater than about ninety degrees Celsius (90° C.). In another aspect, the drying temperature may be no greater than about eighty-nine degrees Celsius (89° C.). In another aspect, the drying temperature may be no greater than about eighty-seven degrees Celsius (87° C.). In another aspect, the drying temperature may be no greater than about eighty-five degrees Celsius (85° C.). In another aspect, the drying temperature may be no greater than about eighty-three degrees Celsius (83° C.). In another aspect, the drying temperature may be no greater than about eighty-two degrees Celsius (82° C.). In another aspect, the drying temperature may be no greater than about eighty-one degrees Celsius (81° C.). In another aspect, the drying temperature may be no greater than about eighty degrees Celsius (80° C.).

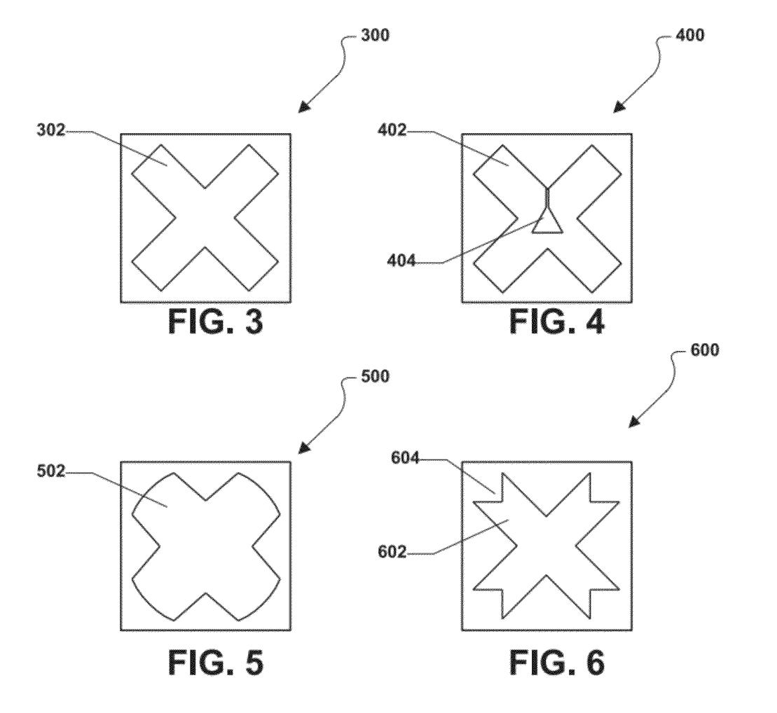

FIG. 3 depicts a first exemplary die, designated 300. As shown, the die 300 may include an X shaped die opening 302. FIG. 4 illustrates a second exemplary die that is designated 400. As depicted, the die 400 may include an X shaped die opening 402 and a triangular mandrel 404 extending into the die opening 402 that may be used to form a triangular hole along the length of an extrudate passing through the die.

Referring to FIG. 5, a third die is shown and is generally designated 500. As shown, the die 500 may include a rounded X shaped die opening 502. FIG. 6 shows a fourth die, designated 600. The fourth die 600 may include a generally X shaped die opening 602. As shown, the distal ends of the X shaped die opening 604 are formed with a V shape 604 that may be used to impart this V shaped channel into an extrudate as it passes through the die 600.

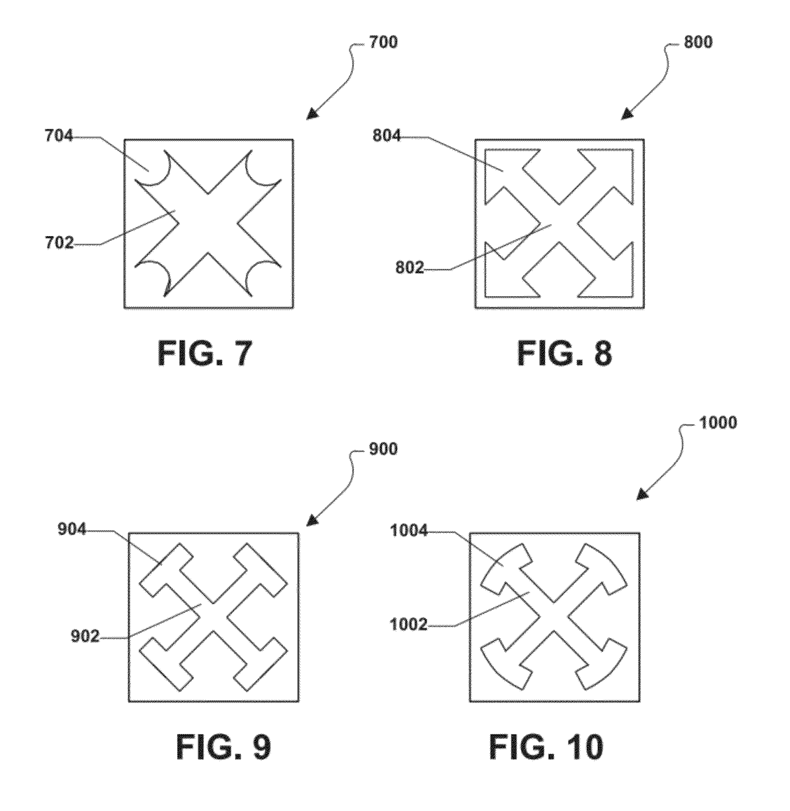

FIG. 7 shows a fifth die, designated 700. The fifth die 700 may include a generally X shaped die opening 702. As shown, the distal ends of the X shaped die opening 704 are formed with a concave shape 704 that may be used to impart a concave channel into an extrudate as it passes through the die 700. FIG. 8 shows a sixth die, designated 800. The sixth die 800 may include a generally X shaped die opening 802. As shown, the distal ends of the X shaped die opening 804 are formed with an arrow shape 804 that may be used to impart this arrow shape into an extrudate as it passes through the die 800.

Referring now to FIG. 9, a seventh die is illustrated and is designated 900. The seventh die 900 may include a generally X shaped die opening 902. As shown, the distal ends of the X shaped die opening 904 are formed with a T shape 904 that may be used to impart this T shape into an extrudate as it passes through the die 900. FIG. 10 shows an eighth die, designated 1000. The eighth die 1000 may include a generally X shaped die opening 1002. As shown, the distal ends of the X shaped die opening 1004 are formed with a rounded T shape 1004 that may be used to impart this rounded T shape into an extrudate as it passes through the die 1000.

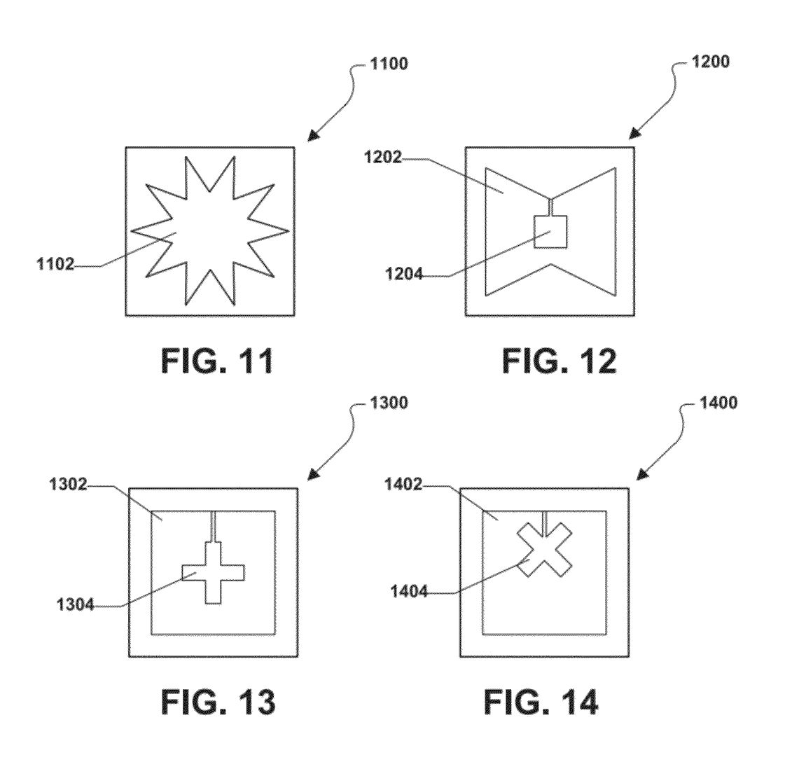

FIG. 11 depicts a ninth exemplary die, designated 1100. As shown, the die 1100 may include a starburst shaped die opening 1102. Material may be forced through the die 1100 to create an extrudate having a starburst shaped cross section. Referring to FIG. 12, a tenth exemplary die is shown and is designated 1200. As depicted, the die 1200 may include an hourglass shaped die opening 1202 and a square mandrel 1204 extending into the die opening 1202 that may be used to form a square hole along the length of an extrudate passing through the die.

FIG. 13 shows an eleventh exemplary die 1300. As depicted, the die 1300 may include a square die opening 1302 and a plus shaped mandrel 1304 extending into the die opening 1302 that may be used to form a plus shaped hole along the length of an extrudate passing through the die.

FIG. 14 shows a twelfth exemplary die 1400. As depicted, the die 1400 may include a square die opening 1402 and an X shaped mandrel 1404 extending into the die opening 1402 that may be used to form an X shaped hole along the length of an extrudate passing through the die. As shown, a center 1406 of the mandrel 1404 may be displaced a distance 1410 from the geometric center 1408 of the die opening 1402.

In a particular embodiment, the center 1406 of the mandrel 1404 is displaced from the geometric center 1408 by a distance that is equal to 0.05 the height (h) of the die opening 1402 along a vertical axis of the die 1400 defining a height. In another aspect, the center 1406 of the mandrel 1404 may be displaced by a distance of at least about 0.1 (h). In another aspect, the center 1406 of the mandrel 1404 may be displaced by a distance of at least about 0.15 (h). In another aspect, the center 1406 of the mandrel 1404 may be displaced by a distance of at least about 0.18 (h). In another aspect, the center 1406 of the mandrel 1404 may be displaced by a distance of at least about 0.2 (h). In another aspect, the center 1406 of the mandrel 1404 may be displaced by a distance of at least about 0.22 (h). In another aspect, the center 1406 of the mandrel 1404 may be displaced by a distance of at least about 0.25 (h). In another aspect, the center 1406 of the mandrel 1404 may be displaced by a distance of at least about 0.27 (h). In another aspect, the center 1406 of the mandrel 1404 may be displaced by a distance of at least about 0.3 (h). In another aspect, the center 1406 of the mandrel 1404 may be displaced by a distance of at least about 0.32 (h). In another aspect, the center 1406 of the mandrel 1404 may be displaced by a distance of at least about 0.35 (h). In another aspect, the center 1406 of the mandrel 1404 may be displaced by a distance of at least about 0.38 (h). In another aspect, the center 1406 of the mandrel 1404 may be displaced by a distance of at least about 0.4 (h). In another aspect, the center 1406 of the mandrel 1404 may be displaced by a distance of at least about 0.42 (h). In another aspect, the center 1406 of the mandrel 1404 may be displaced by a distance of at least about 0.45 (h). In another aspect, the center 1406 of the mandrel 1404 may be displaced by a distance of at least about 0.48 (h). In another aspect, the center 1406 of the mandrel 1404 may be displaced by a distance of at least about 0.5 (h).

In another aspect, the center 1406 of the mandrel 1404 is displaced a distance no greater than 0.95 (h). In yet another aspect, the center 1406 of the mandrel 1404 is displaced a distance no greater than 0.9 (h). In still another aspect, the center 1406 of the mandrel 1404 is displaced a distance no greater than 0.88 (h). In another aspect, the center 1406 of the mandrel 1404 is displaced a distance no greater than 0.85 (h). In still another aspect, the center 1406 of the mandrel 1404 is displaced a distance no greater than 0.83 (h). In yet still another aspect, the center 1406 of the mandrel 1404 is displaced a distance no greater than 0.8 (h). In another aspect, the center 1406 of the mandrel 1404 is displaced a distance no greater than 0.77 (h). In another aspect, the center 1406 of the mandrel 1404 is displaced a distance no greater than 0.75 (h).

By offsetting the hole formed by the mandrel 1404 as described herein. A center of mass of each of the resulting extruded shaped abrasive particles may be moved a corresponding distance from the geometric midpoint of each extruded shaped abrasive particle. Moving the center of mass of each extruded shaped abrasive particle can increase an upright orientation probability. The upright orientation may be considered an orientation that corresponds to a favorable abrasive/grinding position for each shaped abrasive particle and the probability is a simple mathematical probability that the grain lands in the upright orientation.

In a particular aspect, the upright orientation is at least fifty percent (50%). In another aspect, the upright orientation is at least fifty-five percent (55%). In another aspect, the upright orientation is at least sixty percent (60%). In another aspect, the upright orientation is at least sixty-five percent (65%). In another aspect, the upright orientation is at least seventy percent (70%). In another aspect, the upright orientation is at least seventy-five percent (75%). In another aspect, the upright orientation is at least eighty percent (80%). In another aspect, the upright orientation is at least eighty-five percent (85%). In another aspect, the upright orientation is at least ninety percent (90%). In another aspect, the upright orientation is at least ninety-five percent (95%). In another aspect, the upright orientation is at least sixty percent (60%). In another aspect, the upright orientation is one hundred percent (100%).

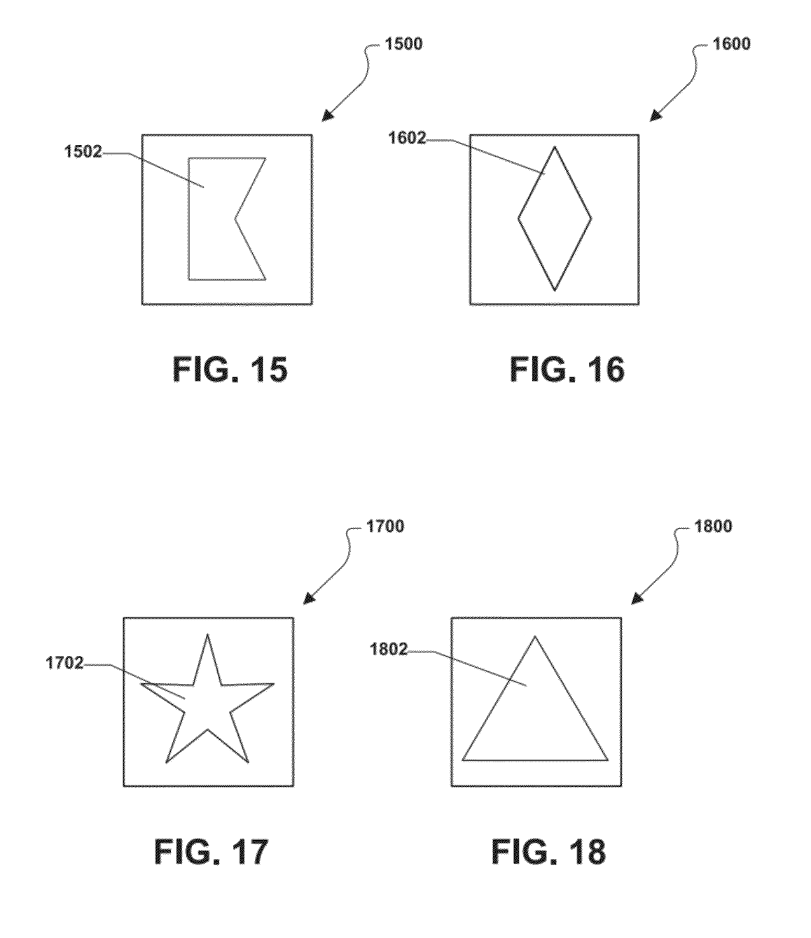

FIG. 15 depicts a thirteenth exemplary die, designated 1500. As shown, the die 1500 may include a K shaped die opening 1502. FIG. 16 illustrates a fourteenth exemplary die that is designated 1600. As depicted, the die 1600 may include a diamond shaped die opening 1602.

FIG. 17 depicts a fifteenth exemplary die that is designated 1700. As shown, the die 1700 may include a star shaped die opening 1702. FIG. 18 illustrates a sixteenth exemplary die that is designated 1800. As depicted, the die 1800 may include a triangular die opening 1802.

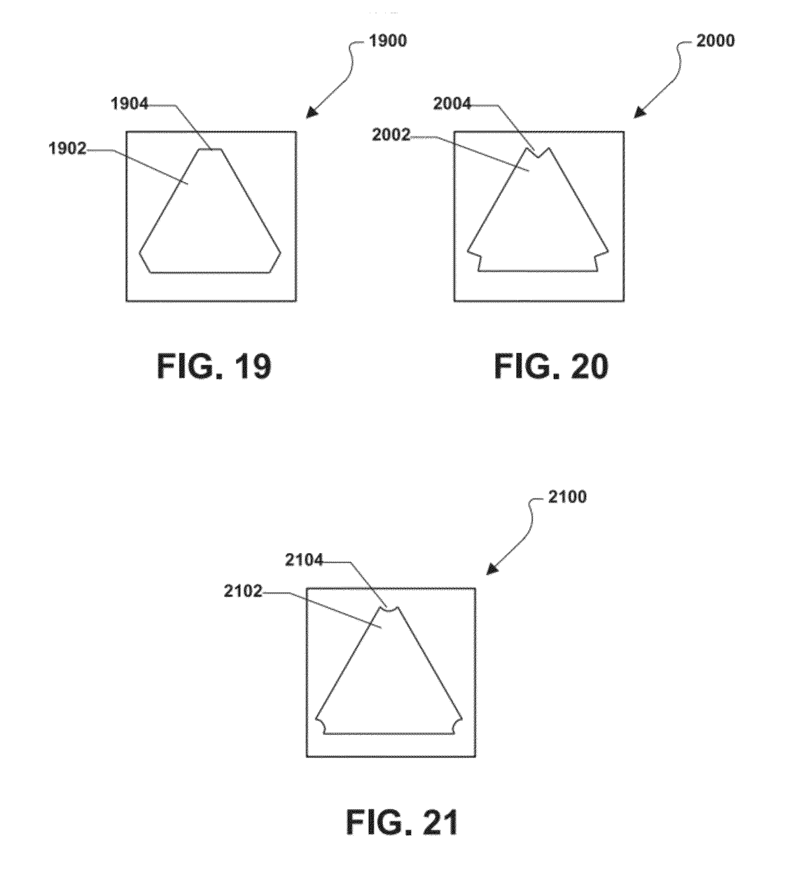

Referring to FIG. 19, a seventeenth exemplary die is shown and is generally designated 1900. As shown, the die 1900 may include a generally triangular die opening 1902. Further, each corner of the triangular die opening 1902 may include a flattened corner structure 1904. It can be appreciated that an extrudate from the die 1900 will have a generally triangular cross section with flattened edges. FIG. 20 illustrates an eighteenth exemplary die that is generally designated 2000. As shown, the die 2000 may include a generally triangular die opening 2002. Further, each corner of the triangular die opening 2002 may include a V shaped corner structure 2004. It can be appreciated that an extrudate from the die 2000 will have a generally triangular cross section with V shaped channels formed in the edges.

FIG. 21 illustrates a nineteenth exemplary die that is generally designated 2100. As shown, the die 2100 may include a generally triangular die opening 2102. Further, each corner of the triangular die opening 2102 may include a convex corner structure 2104. It can be appreciated that an extrudate from the die 2100 will have a generally triangular cross section with concave channels formed in the edges.

It can be appreciated the dies described herein may include die openings with other shapes. For example, the die openings may also be the shape of any alphanumeric character, e.g., 1, 2, 3, etc., A, B, C. etc. Further, the shape of the die openings may be a character selected from the Greek alphabet, the modern Latin alphabet, the ancient Latin alphabet, the Russian alphabet, any other alphabet, or any combination thereof. Moreover, the shape of the die openings may be a Kanji character. Further, although each die is shown with a single die opening, it may be appreciated that each die may include a plurality of die openings having the same shape or combinations of shapes.

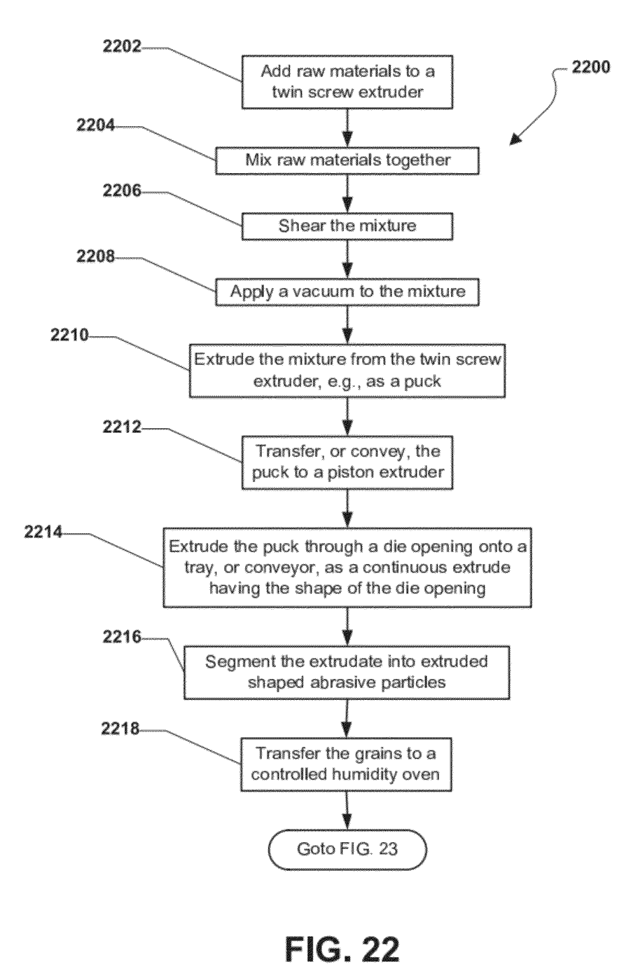

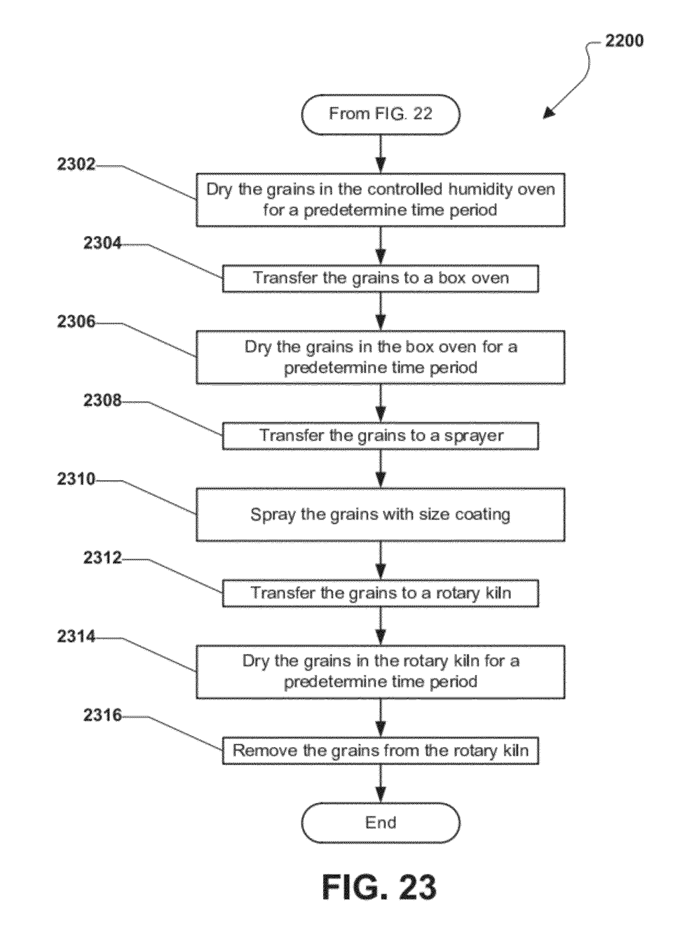

Referring to FIG. 22 and FIG. 23, a method of making extruded shaped abrasive particles is shown and is generally designated 2200. Commencing at block 2202, raw materials may be added to a twin screw extruder. It can be appreciated that an acid may be added to the raw materials to stiffen the resulting sol-gel material. The raw materials may include solid materials and liquids. Further, the raw materials may be added from a solid materials hopper and a liquid reservoir. At block 2204, the raw materials may be mixed together in the twin screw extruder. At block 2206, the mixture may be sheared by the twin screw extruder. Further, at block 2208, a vacuum may be applied to the mixture by the twin screw extruder.

Moving to block 2210, the mixture may be extruded from the twin screw extruder, e.g., as a puck. In a particular aspect, the puck may have a water content that is at least about thirty percent (30%). In another aspect, the water content is at least about thirty-five percent (35%). In yet another aspect, the water content is at least about forty percent (40%). In another aspect, the water content is at least about forty-five percent (45%). In yet another aspect, the water content is at least about fifty percent (50%). In another aspect, the water content is at least about fifty-five percent (55%). In yet another aspect, the water content is at least about sixty percent (60%). In another aspect, the water content is at least about sixty-five percent (65%). In yet another aspect, the water content is at least about seventy percent (70%). In another aspect, the water content is at least about seventy-five percent (75%).

In another aspect, the water content is no greater than about eighty-five percent (85%). In another aspect, the water content is no greater than about eighty-four percent (84%). In another aspect, the water content is no greater than about eighty-three percent (83%). In yet another aspect, the water content is no greater than about eighty-two percent (82%). In another aspect, the water content is no greater than about eighty-one percent (81%). In another aspect, the water content is no greater than about eighty percent (80%).

In another aspect, the water content is no greater than about seventy-nine percent (79%). In another aspect, the water content is no greater than about seventy-eight percent (78%). In another aspect, the water content is no greater than about seventy-seven percent (77%). In another aspect, the water content is no greater than about seventy-six percent (76%). In another aspect, the water content is no greater than about seventy-five percent (75%).

At block 2212, the puck may be transferred, or otherwise conveyed, to a piston extruder. Further, at block 2214, the puck may be extruded through a die opening onto a tray, or conveyor, as a continuous extrudate having the shape of the die opening. At block 2216, the continuous extrudate may be segmented into particles, i.e., extruded shaped abrasive particles. Thereafter, at bock 2218, the grains may be transferred to a first liquid evaporator. In a particular aspect, the liquid evaporator may be a controlled humidity oven. In another aspect, the liquid evaporator may be a microwave oven. In another aspect, the liquid evaporator may be a radio frequency (RF) oven. In yet another aspect, the liquid evaporator may be an infrared (IR) oven. From block 2218, the method 2200 may proceed to block 2302 of FIG. 23.

At block 2302, the grains may be dried in the first liquid evaporator for a predetermined drying time at a predetermined drying temperature. Further, if the liquid evaporator is a controlled humidity oven, the grains may be dried at a predetermined relative humidity. Then, at block 2304, the grains may be transferred to a second liquid evaporator, e.g., a box oven. At block 2306, the grains may be dried in the second liquid evaporator for a predetermined drying time at a predetermined drying temperature. Moving to block 2308, the grains may be transferred to a sprayer. At block 2310, the grains may be sprayed with a size coating.

Proceeding to block 2312, the grains may be transferred to third liquid evaporator, e.g., a rotary kiln. Further, at block 2314, the grains may be dried in the third liquid evaporator for a predetermined drying time at a predetermined drying temperature. At block 2316, the grains may be removed from the third liquid evaporator. Thereafter, the method 2200 may end and the grains may be used in the manufacture of a structured abrasive article as described herein.

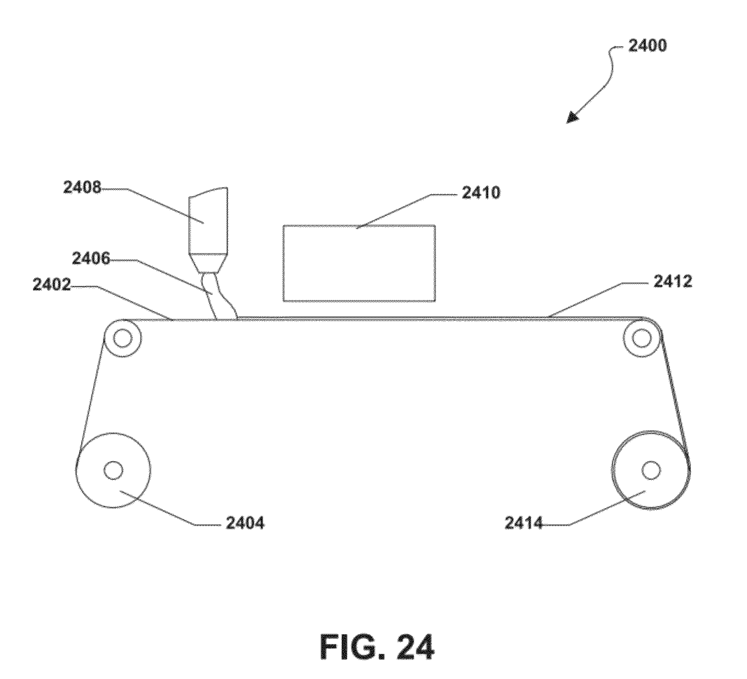

Referring now to FIG. 24, an exemplary process is shown and is generally designated 2400. As shown, a backing 2402 may be paid from a roll 2404. The backing 2402 may be coated with a binder formulation 2406 dispensed from a coating apparatus 2408. An exemplary coating apparatus includes a drop die coater, a knife coater, a curtain coater, a vacuum die coater or a die coater. Coating methodologies can include either contact or non contact methods. Such methods include 2 roll, 3 roll reverse, knife over roll, slot die, gravure, extrusion or spray coating applications.

In a particular embodiment, the binder formulation 2406 may be provided in a slurry that includes the binder formulation and the shaped abrasive particles. In an alternative embodiment, the binder formulation 2406 may be dispensed separate from the shaped abrasive particles. Then, the shaped abrasive particles may be provided following the coating of the backing 2402 with the binder formulation 2406, after partial curing of the binder formulation 2406, after patterning of the binder formulation 2406, or after fully curing the binder formulation 2408. The shaped abrasive particles may, for example, be applied by a technique, such as electrostatic coating, drop coating or mechanical projection. In a particular aspect, the shaped abrasive particles may include one or more combinations of shaped abrasive particles described herein, including a combination of shaped abrasive particles having different shapes as compared to each other.

The binder formulation 2406 may be cured after passing under an energy source 2410. The selection of the energy source 2410 may depend in part upon the chemistry of the binder formulation 2406. For example, the energy source 2410 may be a source of thermal energy or actinic radiation energy, such as electron beam, ultraviolet light, or visible light. The amount of energy used may depend on the chemical nature of the reactive groups in the precursor polymer constituents, as well as upon the thickness and density of the binder formulation 2406. For thermal energy, an oven temperature of about 75.degree. C. to about 150.degree. C. and duration of about 5 minutes to about 60 minutes may be generally sufficient. Electron beam radiation or ionizing radiation may be used at an energy level of about 0.1 MRad to about 100 MRad, particularly at an energy level of about 1 MRad to about 10 MRad. Ultraviolet radiation includes radiation having a wavelength within a range of about 200 nanometers to about 400 nanometers, particularly within a range of about 250 nanometers to 400 nanometers. Visible radiation includes radiation having a wavelength within a range of about 400 nanometers to about 800 nanometers, particularly in a range of about 400 nanometers to about 550 nanometers. Curing parameters, such as exposure, are generally formulation dependent and can be adjusted via lamp power and belt speed.

In an exemplary embodiment, the energy source 2410 may provide actinic radiation to the coated backing, partially curing the binder formulation 2406. In another embodiment, the binder formulation 2406 is thermally curable and the energy source 2410 may provide heat for thermal treatment. In a further embodiment, the binder formulation 2406 may include actinic radiation curable and thermally curable components. As such, the binder formulation may be partially cured through one of thermal and actinic radiation curing and cured to complete curing through a second of thermal and actinic radiation curing. For example, an epoxy constituent of the binder formulation may be partially cured using ultraviolet electromagnetic radiation and an acrylic constituent of the binder formulation may be further cured through thermal curing.

Once the binder formulation 2406 is cured a structured abrasive article 2412 is formed. Alternatively, a size coat may be applied over the patterned abrasive structures. In a particular embodiment, the structured abrasive article 2412 may be rolled into a roll 2414. In other embodiments, fully curing may be performed after rolling a partially cured abrasive article 2412.

In one or more alternative embodiments, a size coat may be applied over the binder formulation 2406 and shaped abrasive particles. For example, the size coat may be applied before partially curing the binder formulation 2406, after partially curing the binder formulation 2406 or after further curing the binder formulation 2406. The size coat may be applied, for example, by roll coating or spray coating. Depending on the composition of the size coat and when it is applied, the size coat may be cured in conjunction with the binder formulation 2406 or cured separately. A supersize coat including grinding aids may be applied over the size coat and cured with the binder formulation 2406, cured with the size coat or cured separately.

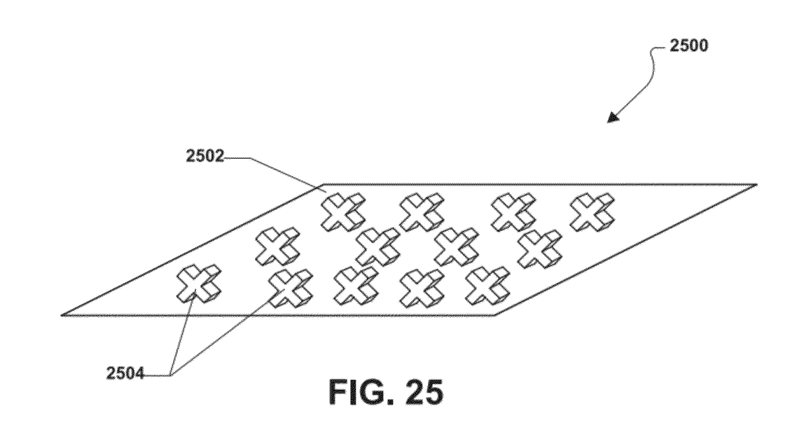

Referring to FIG. 25, a structured abrasive article is shown and is generally designated 2500. As illustrated, the structured abrasive article 2500 may include a backing 2502 and a plurality of shaped abrasive particles 2504 deposited thereon. In a particular aspect, the structured abrasive article 2500 may be manufactured using the process described herein. Further, the shaped abrasive particles 2504 may be made using the extrusion system and method described herein.

In a particular aspect, a body of each of the shaped abrasive particles manufactured using the methods described herein may include a polycrystalline material. The polycrystalline material may include abrasive grains. The abrasive grains may include nitrides, oxides, carbides, borides, oxynitrides, diamond, or a combination thereof. Further, the abrasive grains may include an oxide selected from the group of oxides consisting of aluminum oxide, zirconium oxide, titanium oxide, yttrium oxide, chromium oxide, strontium oxide, silicon oxide, and a combination thereof.

In another aspect, the abrasive grains may include alumina. In yet another aspect, the abrasive grains consist essentially of alumina. Further, the abrasive grains may have an average grain size of not greater than about 500 microns. Alternatively, the average grain size is not greater than about 250 microns. In another aspect, the average grain size is not greater than about 100 microns. In another aspect, the average grain size is not greater than about 50 microns. In another aspect, the average grain size is not greater than about 30 microns. In another aspect, the average grain size is not greater than about 20 microns. In another aspect, the average grain size is not greater than about 10 microns. In another aspect, the average grain size is not greater than about 1 micron.

In another aspect, the average grain size is at least about 0.01 microns. In another aspect, the average grain size is at least about 0.05 microns. In another aspect, the average grain size is at least about 0.08 microns. In another aspect, the average grain size is at least about 0.1 microns.

In another aspect, the body of each of the shaped abrasive particles may be a composite that includes at least about 2 different types of abrasive grains, wherein the abrasive grains can differ by size, composition, shape and a combination thereof.

The system and method described herein may be used to make extruded shaped abrasive particles by extruding sol gel materials. The extrusions/segmenting process allows for the practical manufacture of extruded shaped abrasive particles having a controlled aspect ratio. For example, the aspect ratio may be a ratio of the length of a particular grain to a height of the grain (length:height).

In a particular aspect, the aspect ratio is at least 2:1. In another aspect, the aspect ratio is at least 2.5:1. In another aspect, the aspect ratio is at least 3:1. In another aspect, the aspect ratio is at least 3.5:1. In another aspect, the aspect ratio is at least 4:1. In another aspect, the aspect ratio is at least 4.5:1. In another aspect, the aspect ratio is at least 5:1. In another aspect, the aspect ratio is at least 5.5:1. In another aspect, the aspect ratio is at least 6:1. In another aspect, the aspect ratio is at least 6.5:1. In another aspect, the aspect ratio is at least 7:1. In another aspect, the aspect ratio is at least 7.5:1. In another aspect, the aspect ratio is at least 8:1. In another aspect, the aspect ratio is at least 8.5:1. In another aspect, the aspect ratio is at least 9:1. In another aspect, the aspect ratio is at least 9.5:1. In another aspect, the aspect ratio is at least 10:1.

A high aspect ratio enables the manufacture of a coated abrasive structure having an open coat, i.e., the distance between adjacent shaped abrasive particles may be increased. Further, the open coat provides greater space for chip clearance and may lower power consumption by making a better grind.

Moreover, in bonded abrasive and thin wheel applications shaped abrasive particles having high aspect ratios with sharp edges allows the manufacture of grinding wheels having greater porosity. Greater porosity provides more space for swarf and chip clearance and may enable more coolant to flow through the grinding wheel to provide greater efficiency.

Using the system and method described herein, the resulting extruded shaped abrasive particles may be relatively free of aggregated material. Additionally, the system and method may provide minimal distortion of the extruded shaped abrasive particles and minimal air entrapment in the extruded shaped abrasive particles. The system and method may also minimize water content and minimize drying requirements. Also, the extruded shaped abrasive particles may have substantial microstructural homogeneity.

### EXAMPLE 1

A first sample of extruded shaped abrasive particles are formed from an initial mixture containing a modified boehmitic feedstock material for extrusion that is prepared as described below. Into a 500 gallon stainless steel tank equipped with a sweep agitator and a high shear dispersing blade are charged 2460 lbs of deionized water followed by 216 lbs of alpha alumina seed slurry said slurry having 4% by weight alpha alumina seed. The alpha alumina slurry itself is prepared by milling nano alpha alumina obtained by calcination of seeded sol gel as taught in U.S. Pat. No. 4,657,754. Next, 1188 lbs of boehmite (Catapal B manufactured By Sasol Inc.) is added over a period of 10 minutes followed by 82 lbs of 22% by weight nitric acid. After mixing and shearing for approximately 10 minutes the mixture is continuously fed at a rate of 3.4 gallons per minute with a high pressure pump into a heat exchanger. The heat exchanger is a 1 inch helical stainless steel coil 200 feet in length. The heat exchanger is heated with a hot oil jacket to a temperature of 320 Fahrenheit and a pressure of approximately 100 psi. The heated mixture continues into 420 gallon horizontal autoclave equipped with 3 equal chambers each with a mixing function and the chambers. Additionally, 22% nitric acid is pumped into the first chamber at a rate of 0.04 gallons per minute.

As the slurry emerged from the autoclave, now as a sol, the discharge is controlled with a needle valve and continuously flashed into a conical bottomed stainless steel holding tank, the steam generated is condensed and captured. The solids content of the sol is further increased by passing it through a steam heated stainless steel plate heat exchanger to a solids content of approximately 33% and discharged into an agitated stainless steel holding tank. The sol is then continuously fed to a steam heated double drum dryer. Dried flakes are removed with a scraper, falling into an auger which conveyed the dried flakes into intermediate bulk containers.

Approximately, 375 pounds of drum dried flakes are transferred into a Lancaster mixer model K4 and mixed at “low” speed for 15 seconds. Next, 60 pounds of deionized water and 8 pounds of 29% NH₄OH are added while continuing to mix at low speed over 2 minutes. Then the mixing speed is increased to “high” and mixed for 2 minutes. The homogenized, pellitized, and relatively stiff gel contains just enough water to fill pores and interstices, and is discharged into a hopper.

Next the pelletized gel is discharged in about 10 pound increments into a pug press and the pellets are compressed into 5 inch cylinders. The pressing operation effectively removes most of the air between the pellets. Next, the gel cylinders are put into a piston extruder. A reduced pressure of about 26 inches of Hg is applied to remove gas from the pucks and facilitate extrusion.

The extruder is equipped with a flush mount die system comprising 20 equilateral triangular shaped die openings of approximately 2 mm in length along any side. The aspect ratio of the extruded triangles is controlled by the extrusion rate. A nominal 0.6 mm thickness versus the 2 mm side length is targeted. Nominal extrusion pressure is 60 tons. The extruded shaped abrasive particles having a triangular two-dimensional shape are segmented and gathered. The extruded shaped abrasive particles are dried for approximately 12 hours at ambient temperature and then dried in a box oven at 90° C. for another 12 hours.

The extruded shaped abrasive particles are then calcined through a rotary kiln set at temperature of 800° C. equipped with a 10 inch diameter stainless steel tube manufactured by Harper Furnace Inc. Retention time is controlled via rotation rate and angle of inclination so that retention time at 800° C. is about 10 minutes and the feed rate is about 50 pounds per hour.

After calcination the extruded shaped abrasive particles are sintered in another rotary kiln with a temperature setting of 1300° C. This furnace is equipped with a 9 inch diameter silicon carbide tube. Retention time at 1300° C. is about 25 minutes. The feed rate of about 36 pounds per hour. The density of the sintered shaped abrasive particles is measured by helium pycnometry using an Accupyc Model 1330 manufactured by Micromeretics Corp. and is measured to be 3.91 g/cm3

The sintered shaped abrasive particles are then subjected to a final screening to remove any final aggregates and broken pieces by sieving with the above mentioned SWECO screening device through 14 mesh and retained on 34 mesh.

The sintered shaped abrasive particles performance was evaluated by a single grit scratch test, the results of which are provided in FIG. 25. In a single grit (i.e., shaped abrasive particle) scratch test, a single grit is held in a grit holder by a bonding material of epoxy. The grit is moved across a workpiece of 304 stainless steel for a scratch length of 8 inches using a wheel speed of 22 m/s and an initial scratch depth of 30 microns. The grit produces a groove in the workpiece having a cross-sectional area (A_{R}). Each shaped abrasive particle completes 15 passes across the 8 inch length, for each sample 10 individual particles are tested and the results are analyzed and averaged. The change in the cross-sectional area of the groove from beginning to the end of the scratch length is measured to determine the grit wear.

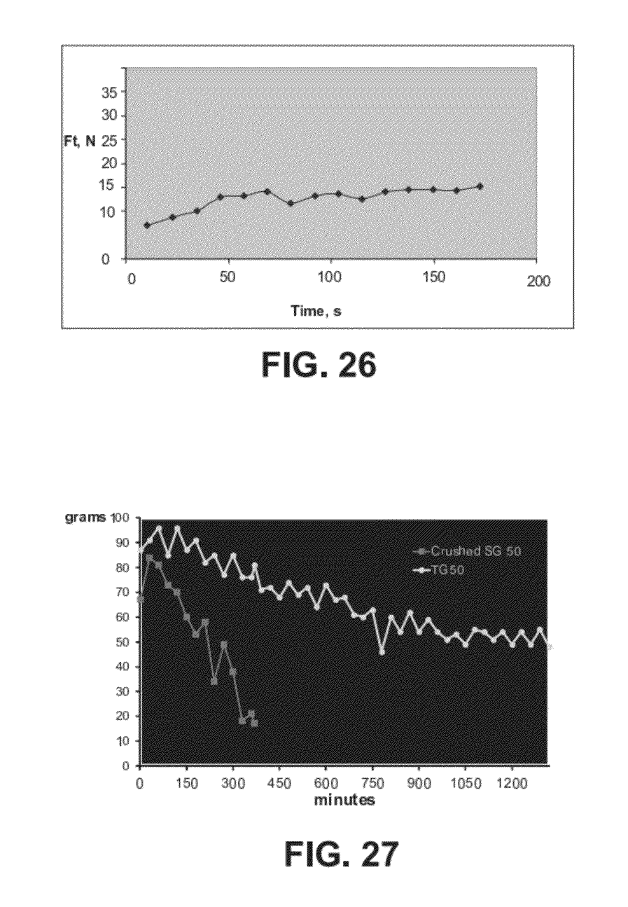

FIG. 26 plots the normal force versus grinding time for a sample of 10 different extruded shaped abrasive particles made according to Example 1. The data shows a relatively long cutting period with only a minor increase in the force during this time, thus indicating an abrasive particle having extensive life and consistent grinding capabilities.

### EXAMPLE 2

Abrasive grains were made using the same method as example 1 except that in this case rods were extruded. The diameter of the circular hole in the die was 0.86 mm. The aspect ratio of the rods was approximately 2:1 length:diameter. A coated abrasive belt was fabricated by conventional means by electrostatically projecting the rods onto a moving web of cloth coated with phenolic resin. A size coat of resin was applied to the belt to ensure grain adhesion and support and the resulting cured belt was tested under the conditions detailed below.
Power Assist Plunge (fixed feed belt tester)—#28669
304 Stainless Steel
1″×1″×48″
450<psi avg.force end pt.
5700 sfpm
18″/min.infeed

It was found that the extruded rods cumulatively cut 1781 grams of the workpiece demonstrating valuable abrasive utility. The results of the test are provided in FIG. 27, which is a plot of cumulative material removed (g) versus time (min.) for the extruded rod sample (TG50) and commercially available conventional crushed alpha alumina grit (Crushed SG 50). Notably, in a comparison of the extruded rods to standard crushed abrasive grit made through the same initial seeding process, the extruded rods outperformed the conventional, crushed abrasive particles.

The above-disclosed subject matter is to be considered illustrative, and not restrictive, and the appended claims are intended to cover all such modifications, enhancements, and other embodiments, which fall within the true scope of the present invention. Further, it may be appreciated that one or more features of a particular aspect or embodiment may be combined with one or more features of another aspect or embodiment to yield a combination of structure not specifically shown or described herein.

1. A method of making abrasive particles comprising:
mixing one or more solids with one or more liquids in a twin screw extruder to form a mixture;
transferring the mixture to a high pressure piston extruder;
extruding the mixture from the high pressure piston extruder through a die to form an extrudate; and
segmenting the extrudate to form an extruded shaped abrasive particle.

2. The method of claim 1, wherein the extrudate has a water content at least about 30 wt % for the total weight of the extrudate.

3. The method of claim 1, wherein the extrudate has a water content of no greater than about 85 wt % for the total weight of the extrudate.

4. The method of claim 1, further comprising:
transferring the extruded shaped abrasive particle to a first liquid evaporator.

5. The method of claim 4, wherein the first liquid evaporator is a humidity controlled oven.

6. The method of claim 4, wherein the first liquid evaporator is a microwave oven.

7.-11. (canceled)

12. The method of claim 1, wherein the extruded shaped abrasive particle is transferred to a first liquid evaporator and remains in the first liquid evaporator for a drying time of at least about two minutes.

13.-15. (canceled)

16. The method of claim 1, further comprising:
transferring the extruded shaped abrasive particle to a second liquid evaporator after transferring the shaped abrasive particle through a first liquid evaporator.

17. The method of claim 1, wherein second liquid evaporator has a different drying temperature than the first liquid evaporator.

18. The method of claim 1, wherein the second liquid evaporator has a different relative humidity than the first liquid evaporator.

19.-20. (canceled)

21. The method of claim 1, wherein the extruded shaped abrasive particle comprises a polycrystalline material.

22.-29. (canceled)

30. The method of claim 1, wherein each extruded shaped abrasive particle is a composite comprising at least about 2 different types of abrasive grains.

31. A method for making abrasive particles, the method comprising:
mixing one or more solids with one or more liquids in a twin screw extruder to form a mixture;
extruding the mixture to form a puck;
transferring the puck to a high pressure piston extruder; and
extruding the puck through a die to form an extrudate.

32.-34. (canceled)

35. The method of claim 31, wherein the die has a die opening comprising a shape selected from the group of two-dimensional shapes consisting of polygonal X-shaped, plus-shaped, numeral, letter, starburst, an hourglass, diamond, a triangle, and a combination thereof.

36.-39. (canceled)

40. The method of claim 31, wherein the die comprises a die opening having a two-dimensional shape of a triangle, and wherein the die opening comprises a corner structure in each corner of the die opening.

41.-43. (canceled)

44. A method for making abrasive grains, the method comprising:
mixing one or more solids with one or more liquids in a twin screw extruder to form a mixture;
shearing the mixture;
applying a vacuum to the mixture to remove water from the mixture;
extruding a puck from the twin screw extruder, wherein the puck comprises a water content of at least about 30 wt % for the total weight of the puck;
transferring the mixture to a high pressure piston extruder;
extruding the mixture from the high pressure piston extruder through a die to form an extrudate; and
segmenting the extrudate to form extruded shaped abrasive particles.

45.-46. (canceled)
